(19) United States
(12) Patent Application Publication
(10) Pub. No.: US 2008/0064319 A1
(43) Pub. Date: Mar. 13, 2008

(54) Air Filter for an Exhaust Fan

(76) Inventor: Lloyd Chezick, East Selkirk (CA)

Correspondence Address: ADE & COMPANY INC., 2157 Henderson Highway, WINNIPEG, MB, R2G1P9, US

(21) Appl. No.: 11/853,465

(22) Filed: Sep. 11, 2007

Related U.S. Application Data
(60) Provisional application No. 60/843,391, filed on Sep. 11, 2006.

(51) Int. Cl. F24F 7/06; B01D 50/00; B65D 69/00

(52) U.S. Cl. 454/341; 206/223; 55/385.1

(57) ABSTRACT

An exhaust fan covering system features a cover body with an open end and at least one opening extending through the cover body. An air filter is arranged to be supported on the cover body between the at least one opening and the open end to force airflow to pass through the filter. An air filter for an existing exhaust fan cover features a frame arranged for support on the exhaust fan to carry filter material such that unobstructed portions of the material are positioned between the at least one opening and the open end of the cover. A filter kit for exhaust fan covers of different sizes features a piece of filter material and at least one template dimensioned for placement over the piece of filter material to define a guide for cutting of the piece of air permeable down to fit an exhaust fan cover of known dimensions.

This application claims the benefit under 35 U.S.C. 119(e) of U.S. provisional application Ser. No. 60/843,391, filed Sep. 11, 2006.

### FIELD OF THE INVENTION

The present invention relates to air filters and more particularly to an air filter assembly for use with or as a cover for an exhaust fan mounted within a recess, for example in a ceiling.

### BACKGROUND OF THE INVENTION

Ceiling mounted exhaust fans, such as those commonly installed in bathrooms to remove moisture or odour from the air, can experience build-up of extraneous material and accordingly become clogged with time. Such build-up can be detrimental to the performance of the fan, and thus it may become necessary to carry out either replacement of fan components or a thorough cleaning thereof, each of which may require some degree of disassembly. As a result, there is a desire for a device that can prevent or reduce build-up within a ceiling mounted exhaust fan assembly in order to increase the lifespan of the fan or reduce the frequency at which cleaning becomes necessary.

### SUMMARY OF THE INVENTION

According to a first aspect of the invention there is provided an exhaust fan covering system for an exhaust fan mountable within a recess, the kit comprising:

a cover body arranged for mounting over the recess, the cover body having an open end with a perimeter sized to surround the recess when mounted thereover and at least one opening extending through the cover body to allow passage of air therethrough; and

an air filter arranged to be supported on the cover body between the at least one opening and the open end to force airflow between the at least one opening and the open end to pass through the air filter.

There may be provided hangers arranged to be supported on the cover body for suspending the cover body over the recess.

The air filter may be arranged to be disposed between the hangers.

The air filter may have at least one opening extending therethrough to allow the hangers to pass through the opening from the cover body.

The air filter may be arranged to extend about the hangers.

The air filter may be arranged to extend fully along a perimeter of the cover body.

The air filter may comprise four inverted trapezoidal panels arranged end to end to outline an inverted frusto-pyramidal volume.

Alternatively, the air filter may comprise four rectangular panels arranged end to end to outline a rectangular volume.

The air filter comprises a layer of air permeable filter material and a frame supporting the layer of air permeable filter material.

The frame may comprise two spaced apart lattices, the layer of air permeable filter material being housed between the lattices.

There may be provided fasteners arranged to fasten the air filter to the cover body.

The cover body may comprise clips arranged to receive the frame of the air filter.

The clips may be arranged to clip the frame of the air filter at an outer perimeter of the air filter.

The filter may have a central opening therein with the clips arranged to clip the frame of the air filter at an inner perimeter of the air filter.

The air filter may comprise fasteners supported on the frame to engage the cover body. In this instance, the fasteners may be clips arranged to extend through respective ones of the openings in the cover body for engagement therewith.

According to a second aspect of the invention there is provided an air filter for an exhaust fan cover having an open end with a perimeter sized to surround a recess in which an exhaust fan is mounted and at least one opening in the exhaust fan cover, the filter comprising:

a frame arranged for support on the exhaust fan cover; and

a layer of air permeable filter material supported by the frame such that portions of the layer of air permeable filter material are unobstructed by the frame to allow air to flow through the at least one layer at those portions, the frame and the layer of air permeable filter material being arranged to position the unobstructed portions thereof between the at least one opening and the open end to force airflow between the at least one opening and the open end to pass through the unobstructed portions of the layer of air permeable filter material.

According to a third aspect of the invention there is provided an air filter kit for exhaust fan covers of a type having an open end with a perimeter sized to surround a recess in which an exhaust fan is mounted and at least one opening in the exhaust fan cover, the air filter kit comprising:

a piece of air permeable filter material;

at least one template dimensioned for placement over the piece of air permeable filter material to define a guide for cutting of the piece of air permeable to reduce at least one dimension thereof to fit the piece of air permeable between the at least one opening and the open end of an exhaust fan cover of known dimensions to force airflow between the at least one opening and the open end to pass through the piece of air permeable filter material.

Preferably the at least one template comprises a plurality of templates, each template being smaller than the piece of air permeable filter material and dimensioned for cutting of the piece of air permeable filter material therealong to fit a respective one of differently dimensioned exhaust fan covers.

Preferably there is provided a perforated blocking member, of greater rigidity than the piece of air permeable material, arranged for positioning between the piece of air permeable filter material and the recess to block motion of the piece of air permeable filter material past the blocking member while allowing airflow therethrough.

### BRIEF DESCRIPTION OF THE DRAWINGS

Exemplary embodiments of the present invention will now be described in conjunction with the accompanying drawings in which:

FIGS. 1A and 1B are top plan and side elevational views respectively of a first type of prior art exhaust fan cover.

FIGS. 2A and 2B are top plan and side elevational views respectively of a second type of prior art exhaust fan cover.

FIG. 3 is an isometric view of a third type of prior art exhaust fan cover.

FIGS. 4A, 4B and 4D are top plan, end elevational and side elevational views respectively of an air filter according to the present invention for an exhaust fan cover of the type shown in FIG. 1. FIG. 4C is a partial cross sectional view taken along line C-C of FIG. 4A.

FIGS. 5A, 5B, 5D and 5E are top plan, end elevational, side elevational and bottom plan views respectively of an air filter similar to that of FIG. 4. FIG. 5C is a partial cross sectional view taken along line C-C of FIG. 5A.

FIG. 6A, 6B and 6C are isometric, top plan and side elevational views respectively of an air filter according to the present invention for an exhaust fan cover of the type shown in FIG. 3.

FIG. 7 is an overhead plan view of an exhaust fan covering kit according to the present invention featuring an exhaust fan cover of the type shown in FIG. 2.

FIG. 8 is a cross sectional view of the exhaust fan covering kit of FIG. 7 as taken along line 8-8 thereof.

FIG. 9 is a cross sectional view, similar to that of FIG. 8, of an alternate embodiment of an exhaust fan covering kit.

FIG. 10 is an overhead plan view of an exhaust fan cover according to the present invention.

FIGS. 11A, 11B, 11C and 11D are top plan, side elevational, end elevational and bottom plan views respectively of another air filter for an exhaust fan cover of the type shown in FIG. 1. FIG. 11 E is a partial cross-sectional view as taken along line E-E of FIG. 11 A.

FIGS. 12A and 12B are top plan and side elevational views respectively of another air filter for an exhaust fan cover of the type shown in FIG. 3. FIG. 12C is a partial cross-section view as taken along line C-C of FIG. 12A.

FIG. 13 is a schematic illustration of an exhaust fan filter kit adapted for use with any user-selected one of a number of standard exhaust fan cover shapes and sizes.

FIG. 14 is a cross-sectional view of a foam block of the exhaust fan filter kit of FIG. 13 having been installed on an exhaust fan cover of the type shown in FIG. 1.

In the drawings like characters of reference indicate corresponding parts in the different figures.

### DETAILED DESCRIPTION

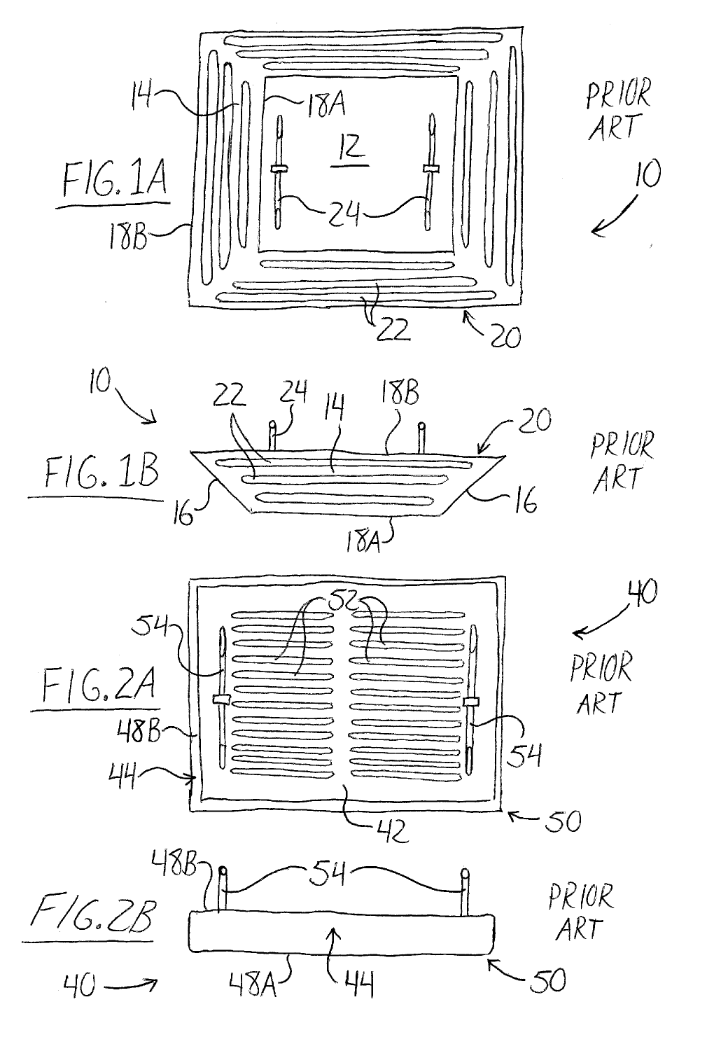

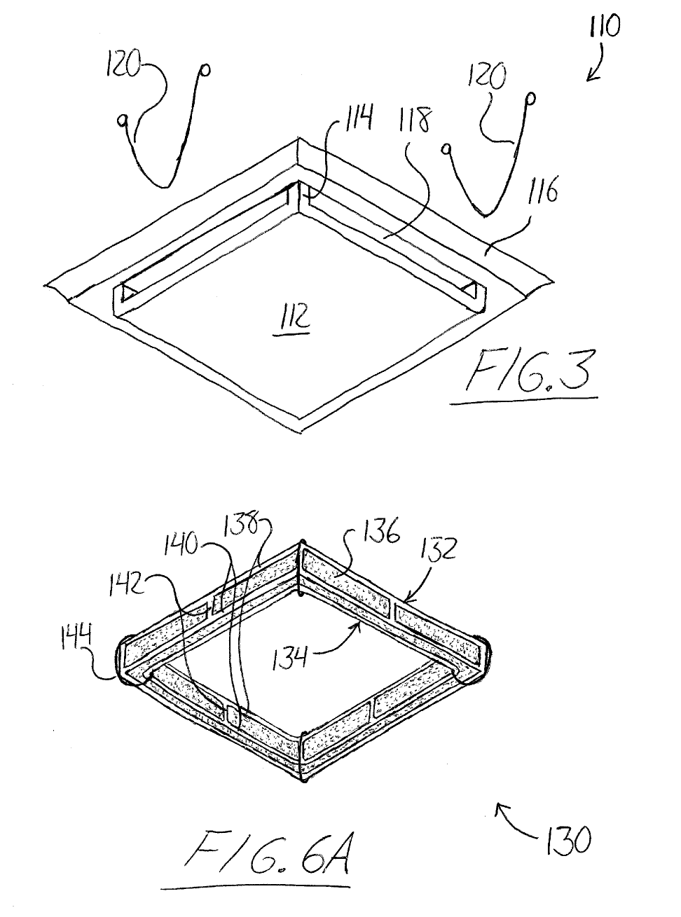

FIGS. 1 to 3 show three different types of conventional covers for ceiling mounted exhaust fans. The present invention relates to providing these and similar types of covers with an air filtering function to prevent build-up and clogging of an exhaust fan.

The tapered cover 10 of FIG. 1 features a rectangular horizontal base 12 defining a bottom surface of the cover. From each side edge of the rectangular base 12 protrudes an inverted trapezoidal side wall 14 extending obliquely outward and upward from a vertical plane in which the side edge is situated. Each inverted trapezoidal side wall 14 is connected to adjacent side walls at its opposite non-parallel ends 16 and connected to the base panel at the shorter of its two parallel sides 18A. The cover body 20 formed by the base 12 and side walls 14 thus outlines an inverted frusto-pyramidal volume having an open top. The longer of the two parallel sides 18B of each side wall 14 defines a respective linear segment of this rectangular open top. Slot-like openings 22 extend along each side wall 14 to allow air flow through the cover body 16 as required for the operation of the exhaust fan (not shown) to be concealed by the cover 10. Hangers 24 are connected to the base 12 to extend upward therefrom to hang the cover body 20 from respective brackets (not shown) provided in the mounting recess of a conventional ceiling exhaust fan.

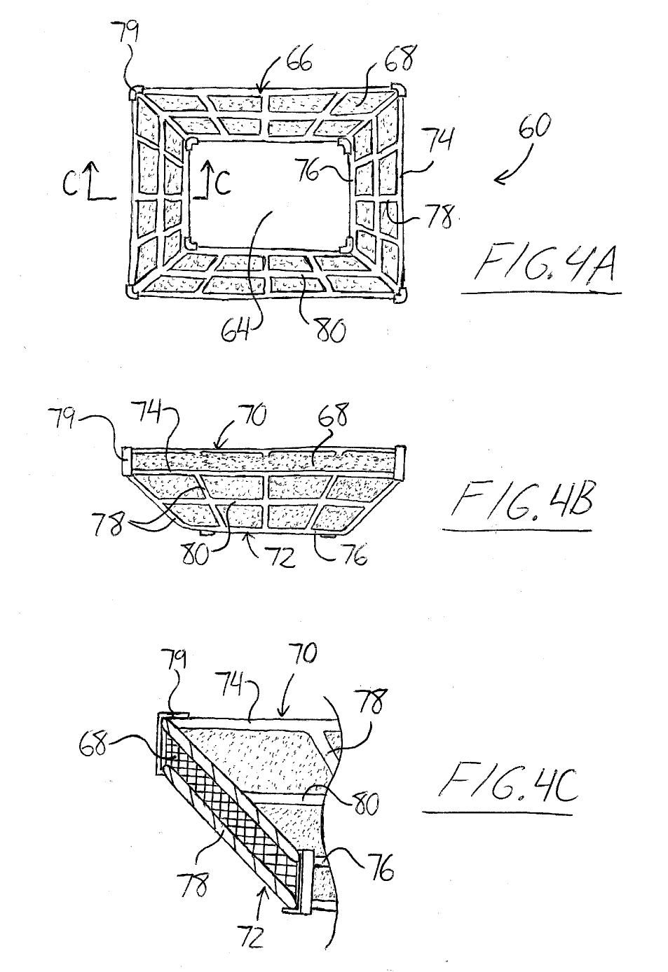

The non-tapered cover 40 of FIG. 2 features a rectangular horizontal base 42 defining a bottom surface of the cover. From each side edge of the rectangular base 42 protrudes a rectangular side wall 44 extending perpendicularly upward therefrom. Each side wall 44 is connected to adjacent side walls at its opposite ends 46 and connected to the base panel at one its two sides 48A. The cover body 50 formed by the base 42 and side walls 44 thus outlines a rectangular volume having an open top. The side 48B of each side wall 14 opposite the base 42 defines a respective linear segment of this rectangular open top. Slot-like openings 52 extend along the base 52 to allow air flow through the cover body 16 as required for the operation of the exhaust fan (not shown) to be concealed by the cover 40. Hangers 54 are connected to the base 42 to extend upward therefrom to hang the cover body 50 from respective brackets (not shown) provided in the mounting recess of a conventional ceiling exhaust fan.

FIG. 3 shows another type of cover 110 having a rectangular horizontal base 112 and four legs 114 extending upward from the base, one at each of the four corners thereof. A rectangular collar 116 extends about and interconnects the four legs 114 to delimit an open top of the cover for communication with a ceiling recess in which a fan is mounted. Each pair of adjacent legs 114 cooperates with the collar 116 and the base 112 to delimit a slot-like opening 118 through which air can pass to reach the fan (not shown) to be concealed by the cover. Hangers 120 are arranged for connection to opposite sides of the collar 116 to suspend the cover body formed by the base 112, legs 114 and collar 116 immediately beneath the ceiling recess in which the fan is mounted.

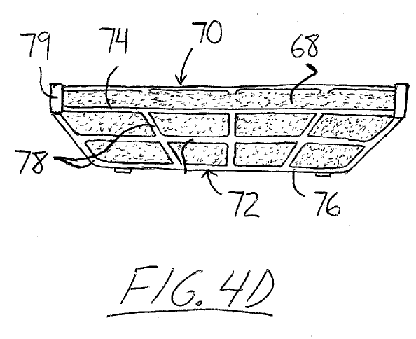

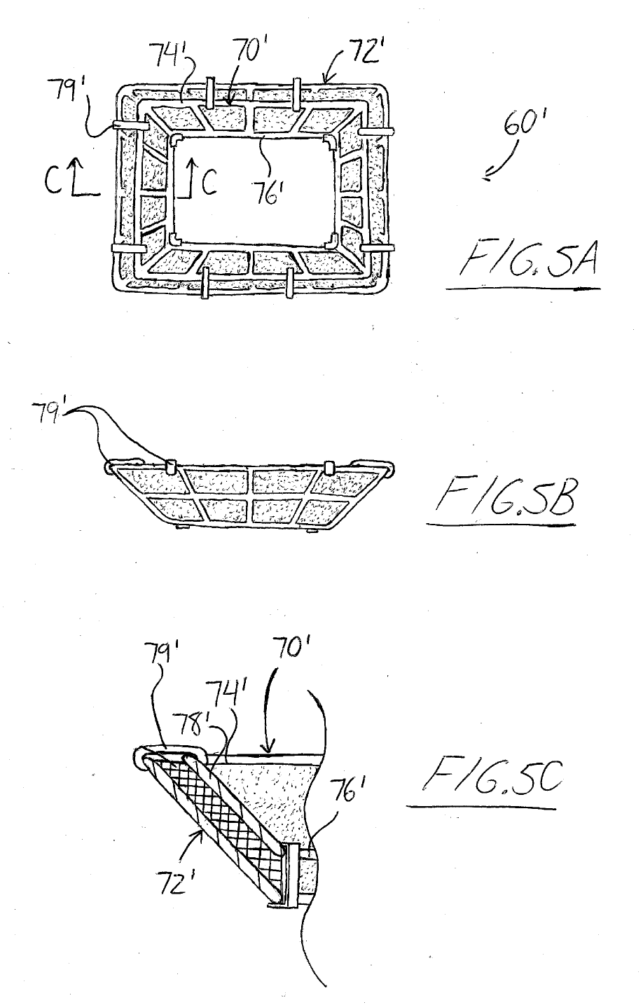

FIG. 4 shows an air filter 60 for use with a fan cover of the type shown in FIG. 1. The filter features four inverted trapezoidal panels 62 similar in size and shape to the side walls 14 of the cover 10. The panels 62 are oriented and positioned relative to one another in the same fashion as the walls of the cover, but the filter 60 does not feature a bottom panel analogous to the base 12 of the cover. As a result, the inverted frusto-pyramidal volume outlined by the panels 62 is open both at the top and bottom so as to define an opening 64 through the filter. The opening 64 is large enough to allow lowering of the filter onto the cover by passing the hangers 24 through the opening to bring the filter 60 into a nested position atop the cover 10. In such a position, each panel 62 sits on a respective side wall 14 of the cover and extends over enough surface area thereof to cover the openings 22.

The air filter 60 features a frame and at least one layer of air permeable filtration material 68. The frame is made up of an upper lattice, or web, 70 nested partially within a lower lattice 72. Between the two lattices is the one or more layers of filtration material 68. Each lattice features an outer perimeter 74 extending about and disposed upward from an inner perimeter 76, with a plurality of ribs 78 extending therebetween. As illustrated, there may be provided a middle perimeter 80 disposed between the inner and outer perimeters. Openings outlined by the perimeter members and ribs allow air passing through the openings 22 of the fan cover 10 to proceed through the filtration material 68 toward the fan being concealed by the cover 10 and protected from build-up and clogging by the air filter 60. The two frame lattices and the filtration material are held in sandwiched relationship by clips 79 connecting the lattices at the corners thereof. In FIG. 4, the upper and lower lattices are identical, and thus share the same dimensions. As shown, this results in the top of the upper lattice being situated at a higher elevation that the top of the lower lattice when the two are nested. Only one side elevational view and one end elevational view are shown, but the two side views are identical, as are the two end views. For embodiments where the perimeters are square, the side and end views would also be identical.

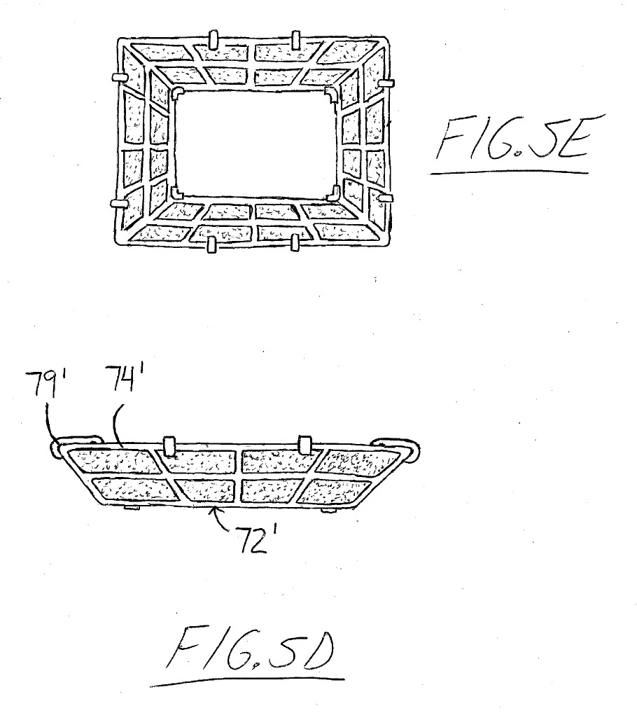

FIG. 5 shows an air filter 60′ similar to the filter 60 of FIG. 4, except that the upper and lower lattices are not identical. The upper lattice 70′ is smaller in overall width and height than the lower lattice 72′. More specifically, the outer perimeter 74′ of the upper lattice 70′ is smaller than that of the lower lattice, but since the inner perimeters delimit equal areas, the ribs 78′ of the upper lattice 70′ are correspondingly shorter than those of the lower lattice. The result is that the outer perimeters of the two lattices are spaced apart by the filtering material, but lie in a common horizontal plane so that the upper lattice nested in the lower lattice does not protrude upward therefrom. Respective segments of the inner perimeters of the two lattices lie in a common vertical plane due to the same size of the two inner perimeters. The ribs of the two lattices could be equal in length if the inner perimeter 76′ was reduced in the same manner as the outer perimeter, which would have the similar result of positioning the inner perimeters within a common horizontal plane. Clips 79′ hook the two lattices together at their outer perimeters between their ribs. Like the filter of FIG. 4, only one side elevational view and one end elevational view are shown, but the two side views are identical, as are the two end views.

The similar filters of FIGS. 4 and 5 each have their advantage. While having the lattices end in a common horizontal plane at the top of the filter may provide a better balance between fully covering the inverted trapezoidal panels of the cover and fitting within the cover's vertical dimensions, using two identical lattices may lower manufacturing costs.

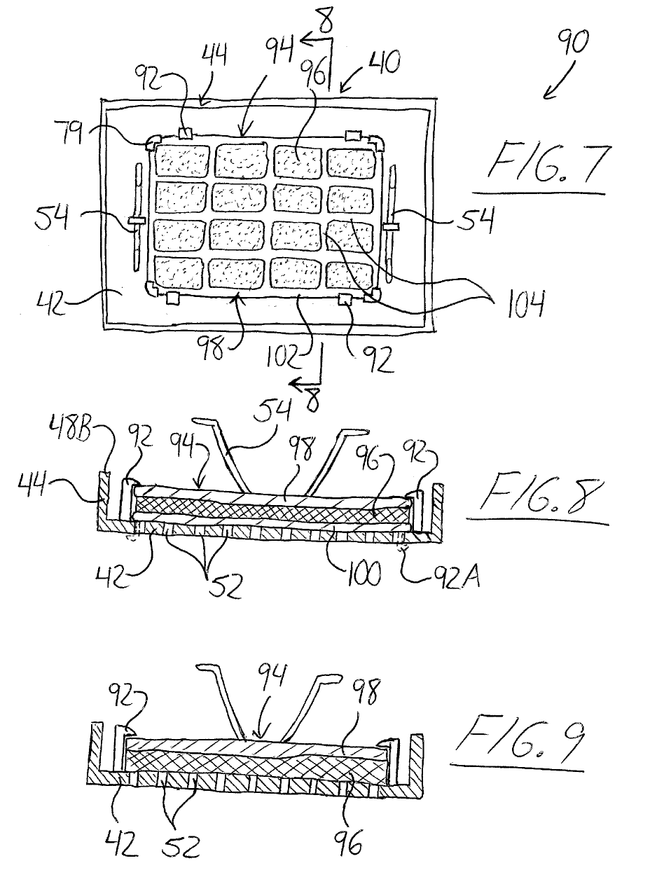

FIGS. 7 and 8 show an exhaust fan covering kit 90 featuring a cover 40 of the type shown in FIG. 2. The cover 40 has been provided with clips 92 protruding upward from the base 42 between the hangers 54 and outward from the openings 52 to secure an air filter 94 onto the cover body in a position covering the slot-like openings 52. The air filter 94 features a frame and at least one layer of air permeable filtration material 96. The frame again is made up of an upper lattice, or web, 98 and a lower lattice 100. As the openings 52 in the cover body are located generally centrally thereon, that is on the base 42 between the hangers 54, rather than along the perimeter of the cover body outward from the hangers as in the cover of FIG. 1, the air filter 94 does not require an opening therein through which the hangers can be passed. As a result, each lattice features a perimeter 102 and a plurality of cross members 104 extending between opposite sides of the perimeter. Each lattice thus defines a two-dimensional array of openings allowing exposure of the filtration material 96 to air. Air flowing through the openings 52 in the cover body is allowed to pass through the filtration material to trap airborne substances and prevent build-up at the fan. The clips 92 engage the upper lattice of the frame at the perimeter thereof to fasten the air filter to the cover.

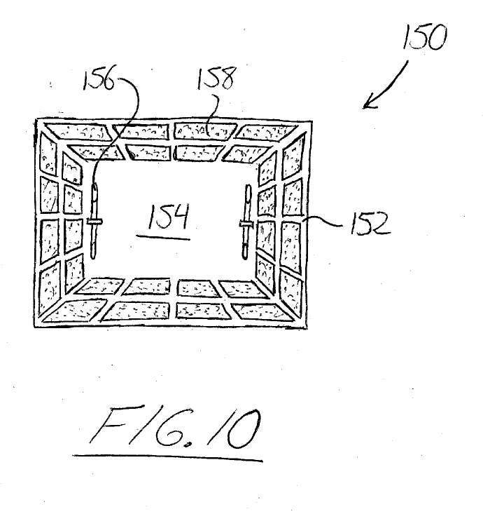

As shown in FIG. 9, it may not be necessary to provide a lower lattice on the air filter, as the filtration material 96 may sit directly upon the base 42 of the cover body for exposure to the air passing through the openings 52.

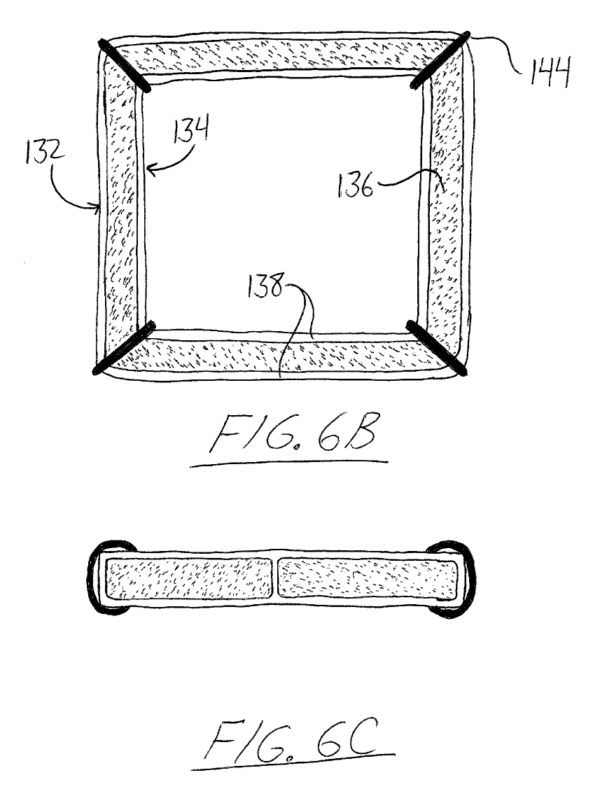

FIG. 6 shows an air filter 130 for the type of exhaust fan cover 110 shown in FIG. 3. The air filter features an outer lattice 132 and an inner lattice 134 with at least one layer of air permeable filtration material 136 disposed therebetween. Each lattice is a fence-like structure having an upper perimeter member 138 and a lower perimeter member 140 connected by ribs 142, the upper and lower perimeters being vertically spaced and having the same dimensions. The perimeter of the inner lattice 134 is smaller than that of the outer lattice such that the inner lattice is disposed concentrically within the outer lattice with the filtration material 136 housed between them. The filter 130 is sized to sit upon the base 112 of the cover 110 with its corners fitting into those defined by the right-angle legs 114 extending upward from the base to the collar 116. In this arrangement, each opening 118 in the cover body is covered by a respective rectangular panel of the filter 130 formed by one side of the outer lattice 132, a respective side of the inner lattice 134 and the filter material 136 housed therebetween. Ties 144 spaced about the filter at the corners thereof and each wound tightly around the lattices illustrate that the layered arrangement of the lattices and filtering material may be held together by inter-lattice connections other than clips.

The air filters of the present invention may be marketed in a number of possible ways. An air filter may be provided as part of an exhaust fan installation kit, as part of a replacement exhaust fan covering kit or as alone as an addition for an existing exhaust fan cover. In kit packages, the cover may include releasable fasteners for selectively attaching and detaching the cover and air filter. For example, the covers of FIGS. 1 and 3 may be provided with clips, like those of FIGS. 7 to 9, extending upward from the base panel to latch onto the filter. It should be appreciated that such clips would be situated inward from the openings with the engaging shoulders of the clips extending outward to catch on the inner perimeter of the filter. Alternatively, such clips could be provided on an air filter, which would allow the filter to be sold either as an add-on for an existing cover or as part of a kit including a cover. Such an arrangement is shown with broken lines in FIG. 8. The filter clips 92A extend downward from the lower lattice 100 of the filter 94 so as to be passable through respective ones of the openings 52 in the base 42 of the cover body to engage therewith.

Various air filter materials are known, and include paper, synthetics, foam, cotton and statically charged elements. For example, the one or more layers of filtration material in the filters of the present invention may include a single layer of one material, such as foam, disposed between two statically charged elements which attract charged particles to improve retention of unwanted materials. The air filters may be washable to extend the lifespan of the filter through cleaning and reuse. As described above, the filters and covers may be arranged to allow removal of the filter from the cover for cleaning or replacement. Alternatively, the air filter may be built-in to the cover itself, as conventional cover hangers allow quick and easy removal of the cover from over the fan's mounting recess, meaning that the entire cover could simply be removed for cleaning or replacement as needed.

FIG. 10 shows a one-piece cover and air filter 150 having a shape similar to the conventional cover of FIG. 1. A plurality of openings extend along the perimeter of the cover body in the side panels 152 outward from the central base panel 154 on which the hangers 156 are supported. A layer of filtering material 158 is supported by the cover body to extend over each of the openings therethrough. While multiple openings are shown in each of the side panels 152, just like the filter 60 of FIG. 4, it should be appreciated that fewer and larger openings could be used, for example one opening per side panel. In this one-piece embodiment, the exhaust fan cover body may be of a two-piece construction sandwiching the filter material between two halves of the cover body, much like the add-on filter embodiment of FIG. 4 but with a solid central base panel 154 closing the bottom of the structure at the center thereof, as shown in FIG. 10, to force air to pass through the filter covered openings at the side panels. A similar one-piece cover and filter could be made in the style of the conventional cover of FIG. 2, for example having filter material mounted to the cover body in a position over as little as one large central opening, or a plurality of smaller openings or slots as shown in FIG. 2, in the base.

It should be appreciated that the present invention may be applied to exhaust fan covers of other styles and other mounting arrangements. For example, the filters of the present invention may be used with covers not horizontally mounted as in a ceiling exhaust fan, for example a wall-mounted exhaust fan where the cover is oriented vertically against a vertical wall into which an exhaust fan has been recessed and mounted. Fasteners other than clips may be used to secure filters to exhaust fan cover bodies.

Filter frames of other constructions known to those of skill in the art may be applied in place of the layered lattice and filter material arrangement.

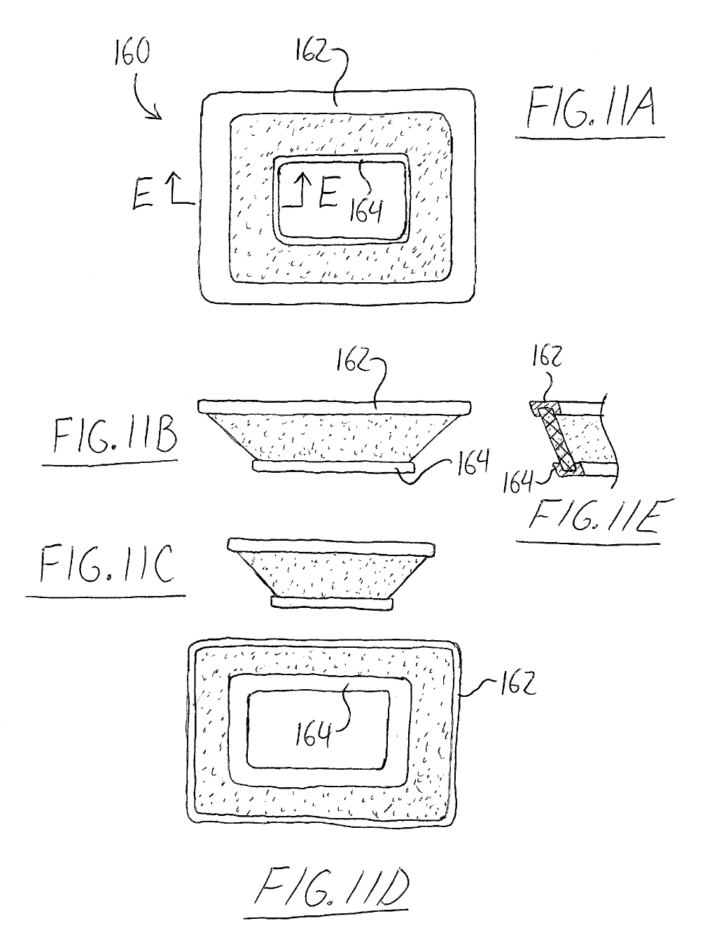

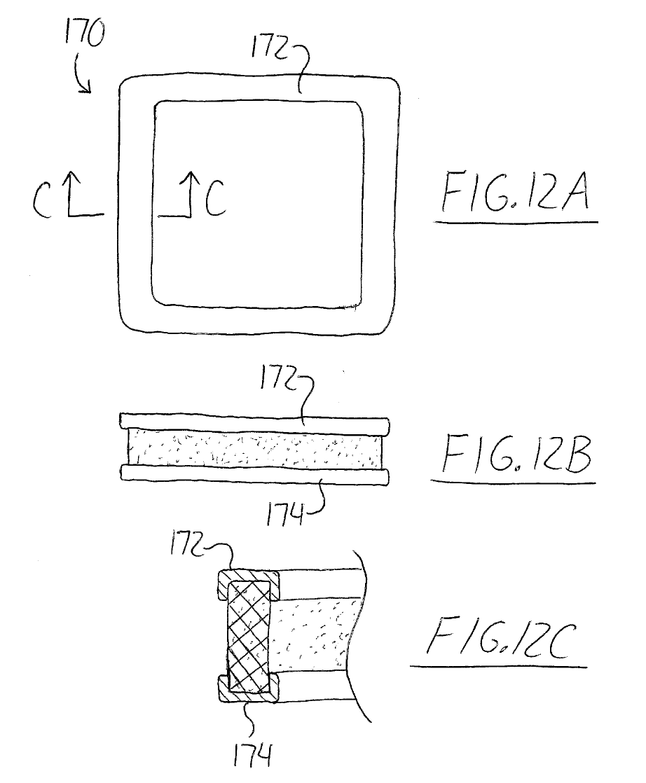

FIG. 11 shows a filter 160 for use with a cover of the type shown in FIG. 1. The frame of the filter consists of an upper collar 162 extending about the outside perimeter of the filter and housing the upper edge of the filtering material layer(s) and a lower collar 164 extending about the inside perimeter of the filter and housing the lower edge of the filtering material layer(s). As shown in the cross section of FIG. 11 E, the collars are generally U-shaped in cross section to receive the filtering layer(s) between the legs of each cross section, the legs of the two U-shaped cross sections extending toward one another. In other words, the filter material is received in and secured to the open end of the U-shaped cross section of each frame collar. Only one side elevational view and one end elevational view are shown, but the two side views are identical, as are the two end views. For embodiments where the perimeters are square, the side and end views would also be identical.

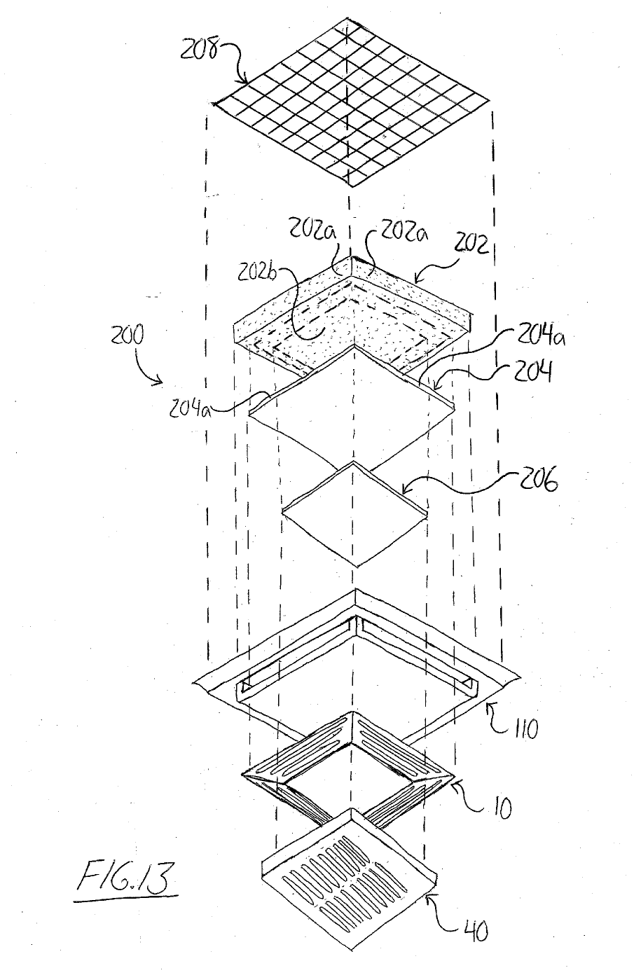

FIG. 12 shows a filter 170 for use with a cover of the type shown in FIG. 3, but with a collar style frame like the filter of FIG. 11. The frame of the filter 1 70 consists of an upper collar 1 72 extending along the perimeter of the filter at the top thereof to house the upper edge of the filtering material layer(s) and a lower collar 164 extending along the perimeter of the filter at the bottom thereof to house the lower edge of the filtering material layer(s). As shown in the cross section of FIG. 12C, the collars are again generally U-shaped in cross section to receive the filtering layer(s) between the legs of each cross section, the legs of the two U-shaped cross sections extending toward one another. In other words, the filter material is received in and secured to the open end of the U-shaped cross section of each frame collar. Only one side elevational view is shown, but it should be appreciated that due to the square perimeter of the filter 170, all sides have an identical appearance. The top and bottom views of the filter are also identical.

To retain their shape, filters using collar-style frames may either use filtering material of sufficient stiffness to retain the relative positioning of the upper and lower collars or provide stiffening or reinforcement members extending between the collars. For example, the collars may be used in conjunction with lattices disposed on opposite sides of each segment of the filtering layer(s), the U-shaped cross section of the collars housing both the filtering material and the lattices, webs or grids between them in the open side of the U-shaped cross section.

Where lattices, or webs, are used in a layered configuration, they may be connected by elements other than clips, ties or collars. The frame elements may be made of plastic, wire or other suitable material known to those of skill in the art. Although described herein above in the context of fan covers for ceiling mounted fans, the present invention may be adapted for use with other mounting arrangements, for example exhaust fans recessed into a vertical wall. An air filter may be arranged to simply rest atop the exhaust fan cover rather than being fastened thereto. For example, in embodiments where the filter horizontally extends close enough to the outer perimeter of the cover so as to extend past the opening of the recess in which the fan is mounted and vertically extends to the top the cover, the filter would be effectively clamped against the cover openings by the cover and the surface from which the fan is recessed, for example a ceiling.

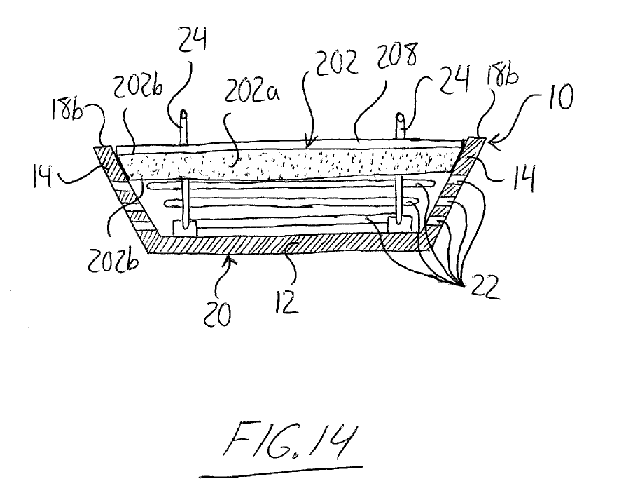

FIG. 13 shows an exhaust fan filter kit 200 made up of a rectangular foam block 202 and two rectangular templates 204, 206 each made of a thin plate of rigid material. The sizes of the foam block and the two templates correspond to standard different sizes of exhaust fan covers available on the market, as represented in the figure by the three conventional cover types 10,40,110 described herein above and pictured separately in FIGS. 1, 2 and 3 respectively. In FIG. 10, the foam block 202 is initially dimensioned to fit snugly between the four legs 114 atop the rectangular base 112 of cover 110 so that the four side edges 202a between the two parallel end faces 202b of the block 202 fit against the slot-like openings 118 extending along the edges of the rectangular base 112 between the legs 114 projecting upward at the corners thereof. The block is of sufficient thickness to cover the full height of the openings 118. The block thus covers the openings so that any airflow drawn through the openings 119 toward the exhaust fan through the open top end of the cover 110 is forced to pass through the air-permeable foam, which acts to filter particulate matter from the air. If the purchaser or other end user of the kit wishes to use it on a smaller exhaust fan cover, as represented by the tapered cover 10 in the Figure, then the corresponding template 204 is laid flat on a face 202b of the block 202 so as not to project past any edges thereof, and a cutting blade is used to cut the foam block 202 along the edges 204a of the flat template 204 to reduce the size of the block to that suitable for mounting in that particular cover 10. If the user wishes to instead install a filter on an even smaller exhaust fan cover, as represented by cover 40 in the figure, then the smallest template 206 is instead laid on the face 202b of the block and cut around to reduce the block size to dimensions appropriate to fit that particular cover. The same filter kit can thus be used to equip any of a plurality of differently sized exhaust fan covers with a filter.

FIG. 14 shows the foam block 202 having been cut down using the larger template 204 and installed in the tapered cover 10. The resulting length and width dimensions of the block's face 202b are such that the block 202 is supported by the sloped trapezoidal side walls 14 projecting obliquely outward from the rectangular base 12 upward therefrom so that the top face is disposed substantially flush with the open top end of the cover 10. This way the slot-like openings 22 in the side walls 14 are disposed below the foam block 202 so that airflow between the slots 22 and the open top end of the cover 10 is forced to pass through the filtering foam block. Even if the thickness of the foam block is such that it extends downward from the open top of the cover fully or partially past the uppermost of the slots 22, the template is sized to be slightly larger than the open top end of the cover 10 and this overlap or interference fit cooperates with the flexibility and resiliency of the foam to ensure a good seal between the foam block 202 and the upper ends of the angled side walls 14 above the uppermost slot. This prevents airflow from bypassing the filter through gaps left between the foam and the cover. This positioning of the foam block illustrates that the filters of the present invention need not necessarily be placed directly over the openings in the exhaust fan covers, but instead must be placed somewhere between the openings and the open upper end in a way that extends fully across communicating space therebetween. This may be achieved by mounting the filtering material to cover all the openings, as in the embodiments of FIGS. 3 to 12, or by mounting the filtering material to cover the open upper end as shown in FIG. 10. As the perimeter of the open upper end extends around the recess in which the exhaust fan is installed in flush engagement with the surrounding surface when the cover is mounted in place, passage of air into the recess to the exhaust fan is basically limited to flow through the openings in the fan cover and upward through the open upper end thereof. Positioning the filter material fully across the openings or open upper end limits fluid communication therebetween to passage through the filter material.

FIG. 14 also shows that where a resilient filter material such as foam is used, wire hangers conventionally used to support an exhaust fan cover over the opening of the fan-containing recess can simply be manually passed through the filter material by the installer without significant detriment to the effectiveness of the filter, as the resiliency of the material will tend to seal the filter material around the wire hanger so passed therethrough. The smaller template 206 may therefore be sized small enough to fit the foam block between the hangers 56 of cover 40 (see FIG. 2) or my instead be sized to have the foam block 202 resiliently engage against the rectangular side walls 44 projecting upward from the rectangular base 42, to better hold the block in place thereatop, once having the wire hangers 54 pushed therethrough and being fed down thereover onto the base 42.

As shown in FIG. 13, the kit 200 may also include a flat rectangular plastic or wire mesh or grid 208 of slightly larger dimensions than the foam block 202. The mesh 208 has greater rigidity than the foam block 202 so that it can be positioned to cover the recess which the foam-equipped fan cover is to be positioned over to prevent the flexible foam block from being sucked into the recess toward the exhaust fan mounted therein. The grid 208 thus defines a relatively rigid blocking member having a series of openings or perforations therein to block the relatively flexible foam block 202 from passing by it toward the exhaust fan while allowing airflow through it. Like the foam block, the grid may be cut down in size by the installer of the fan cover to fit within the perimeter of the open upper end of a specific fan cover while spanning fully across the opening of the recess in the ceiling or other surface in which the fan is mounted. The openings in the grid 208 are each sufficiently small to prevent the foam block from being pulled therethrough under operation of the exhaust fan.

FIG. 14 shows the blocking member grid 208 positioned atop the foam block 202 at the open upper end of the tapered exhaust fan cover 10. The grid 208 has been cut to fit just within the rectangular perimeter of the open upper end to extend fully between the opposite side panels 14 of the cover 10, as defined by the longer sides 18b of the inverted trapezoidal side walls 14. So positioned, the grid 208 will extend fully across the opening of the fan-containing recess to pass its opposite sides thereof when the fan cover 10 is hung in place, so that any lifting tendency of the foam block 202 from the cover 10 toward the exhaust fan in the recess is blocked by contact of the grid 208 with the surface into which the recess extends at points surrounding the opening thereto. As shown, the openings in the grid 208 allow the hangers 24 of the exhaust fan cover 10 to pass therethrough to suspend the cover from the recess in a known fashion. Like for the foam block 202, templates may be provided for cutting the grid 208 down to a predetermined size to properly fit with a known size or style of exhaust fan cover.

It should be appreciated that although FIG. 13 shows two templates, a kit for use with exhaust fan covers of different sizes may feature a different number of templates. For example, where the block of foam is dimensioned to fit a particular size or style of cover right out of the box, providing only a single template will still allow use of the same kit with either of two different sizes. On the other hand, more than two templates may be provided to facilitate use of the kit among a wider selection of covers. Filtering materials other than foam may be used in the adaptive kit of FIG. 13, with flexible resilient materials having the potential advantages of a snug fit with the cover and the option of passing wire hangers through the material without requiring preformed openings to maintain a good seal and maximize the percentage of air flow through forced to pass through the filter material. Although shown as rectangular plates, templates of different shapes may be provided to cut the foam block into pieces of particular shape to fit within correspondingly shaped exhaust fan covers. For example, the foam block may cut into four separate trapezoidal pieces to individually fit directly over the side panels 14 of the tapered fan cover 10, with the grid 208 being cuttable into similar shapes for individual fastening to the fan cover over the respective foam pieces, for example by tie straps tied around cross members through the openings in the fan cover.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An exhaust fan covering system for an exhaust fan mountable within a recess, the kit comprising:
a cover body arranged for mounting over the recess, the cover body having an open end with a perimeter sized to surround the recess when mounted thereover and at least one opening extending through the cover body to allow passage of air therethrough; and
an air filter arranged to be supported on the cover body between the at least one opening and the open end to force airflow between the at least one opening and the open end to pass through the air filter.

2. The system according to claim 1 further comprising hangers arranged to be supported on the cover body for suspending the cover body over the recess.

3. The system according to claim 2 wherein the air filter is arranged to be disposed between the hangers.

4. The system according to claim 2 wherein the air filter has at least one opening extending therethrough to allow the hangers to pass through the opening from the cover body.

5. The system according to claim 2 wherein the air filter is arranged to extend about the hangers.

6. The system according to claim 1 wherein the air filter is arranged to extend fully along a perimeter of the cover body.

7. The system according to claim 4 wherein the air filter comprises four inverted trapezoidal panels arranged end to end to outline an inverted frusto-pyramidal volume.

8. The system according to claim 4 wherein the air filter comprises four rectangular panels arranged end to end to outline a rectangular volume.

9. The system according to claim 1 wherein the air filter comprises a layer of air permeable filter material and a frame supporting the layer of air permeable filter material.

10. The system according to claim 9 wherein the frame comprises two spaced apart lattices, the layer of air permeable filter material being housed between the lattices.

11. The system according to claim 1 wherein the kit further comprises fasteners arranged to fasten the air filter to the cover body.

12. The system according to claim 9 wherein the cover body comprises clips arranged to receive the frame of the air filter.

13. The system according to claim 12 wherein the clips are arranged to clip the frame of the air filter at an outer perimeter of the air filter.

14. The system according to claim 12 wherein the filter has a central opening therein and the clips are arranged to clip the frame of the air filter at an inner perimeter of the air filter.

15. The system according to claims 9 wherein the air filter comprises fasteners supported on the frame to engage the cover body.

16. The system according to claim 15 wherein the fasteners comprise clips arranged to extend through respective ones of the openings in the cover body for engagement therewith.

17. An air filter for an exhaust fan cover having an open end with a perimeter sized to surround a recess in which an exhaust fan is mounted and at least one opening in the exhaust fan cover, the filter comprising:
a frame arranged for support on the exhaust fan cover; and
a layer of air permeable filter material supported by the frame such that portions of the layer of air permeable filter material are unobstructed by the frame to allow air to flow through the at least one layer at those portions, the frame and the layer of air permeable filter material being arranged to position the unobstructed portions thereof between the at least one opening and the open end to force airflow between the at least one opening and the open end to pass through the unobstructed portions of the layer of air permeable filter material.

18. An air filter kit for exhaust fan covers of a type having an open end with a perimeter sized to surround a recess in which an exhaust fan is mounted and at least one opening in the exhaust fan cover, the air filter kit comprising:
a piece of air permeable filter material;
at least one template dimensioned for placement over the piece of air permeable filter material to define a guide for cutting of the piece of air permeable to reduce at least one dimension thereof to fit the piece of air permeable between the at least one opening and the open end of an exhaust fan cover of known dimensions to force airflow between the at least one opening and the open end to pass through the piece of air permeable filter material.

19. The kit according to claim 18 wherein the at least one template comprises a plurality of templates, each template being smaller than the piece of air permeable filter material and dimensioned for cutting of the piece of air permeable filter material therealong to fit a respective one of differently dimensioned exhaust fan covers.

20. The kit according to claim 18 further comprising a perforated blocking member, of greater rigidity than the piece of air permeable material, arranged for positioning between the piece of air permeable filter material and the recess to block motion of the piece of air permeable filter material past the blocking member while allowing airflow therethrough.
